(19) United States
(12) Patent Application Publication
(10) Pub. No.: US 2014/0218646 A1
(43) Pub. Date: Aug. 7, 2014

(54) Variable-Magnification Optical Loupe

(71) Applicant: KERR CORPORATION, Orange, CA (US)

(72) Inventor: Brian L. Wilt, Verona, WI (US)

(73) Assignee: KERR CORPORATION, Orange, CA (US)

(21) Appl. No.: 13/758,776

(22) Filed: Feb. 4, 2013

(51) Int. Cl. G02B 7/00; G02F 1/13

(52) U.S. Cl. CPC G02B 7/002; G02F 1/1313
USPC 349/13; 359/694

(57) ABSTRACT

An optical loupe assembly includes mechanical or electromechanical apparatus for varying the magnification of objects viewed through the loupe and or varying a working distance of the loupe. In another embodiment, an optical loupe may include a lens system comprising one or more liquid lens assemblies or liquid crystal lens assemblies for providing variable magnification.

### CROSS-REFERENCE

This application is a continuation of International Patent Application No. PCT/US2011/046225 filed Aug. 2, 2011 (pending) which claims priority to U.S. Provisional Patent Application Ser. No. 61/371,061 filed Aug. 5, 2010 (expired), and U.S. Provisional Patent Application Ser. No. 61/378,129 filed Aug. 30, 2010 (expired), the disclosures of which are incorporated by reference herein in their entirety.

### TECHNICAL FIELD

The present invention relates generally to magnifying devices, and more particularly to an optical loupe having variable magnification capability.

### BACKGROUND

Magnification viewers, including, but not limited to, pairs of magnification loupes, are worn by dentists and surgeons for extended periods of time during clinical procedures. These viewers are worn to provide clarity of view while avoiding a hunched-over position that can, over time, result in debilitating neck and back strain and can also have an adverse effect on the success of the procedure being performed. Magnification viewers allow a practitioner to operate at a greater working distance from a patient than without the viewers. Higher magnification viewers also reduce the practitioner's exposure to aerosols and other substances.

Generally, the optical loupes of a magnification viewer have a fixed magnification power. If a user desires to view an object at a greater or lesser magnification, a different optical loupe must be used, or lens elements must be changed to provide the desired magnification. A need exists for a magnification viewer that is capable of providing variable magnification without the need to change lens elements.

### SUMMARY

The present invention overcomes the foregoing and other shortcomings and drawbacks of optical loupes heretofore known. While the invention will be described in connection with certain embodiments, it will be understood that the invention is not limited to these embodiments. On the contrary, the invention includes all alternatives, modifications and equivalents as may be included within the spirit and scope of the present invention

According to one aspect of the present invention, an optical loupe includes an electromechanical apparatus for varying the magnification of objects viewed through the loupe. In another embodiment, an optical loupe may include a manually actuatable mechanism that allows a user to selectively vary the magnification of objects viewed through the loupe. In yet another embodiment, an optical loupe includes one or more liquid lenses for varying the magnification of objects viewed through the loupe. In still another embodiment, an optical loupe includes at least one liquid crystal lens that facilitates varying the magnification of objects viewed through the loupe by varying a voltage applied to the lens.

Other objects, features and advantages of the present invention will be readily understood after reading the following detailed description together with the accompanying drawings.

### BRIEF DESCRIPTION OF THE FIGURES

FIG. 1A is a schematic representation of an exemplary optical loupe assembly utilizing an electromechanical apparatus to vary the magnification of objects in accordance with the principles of the present invention.

FIG. 1B is a schematic representation of another exemplary optical loupe assembly utilizing an manual mechanical apparatus to vary the magnification of objects in accordance with the principles of the present invention.

FIG. 2 is a schematic representation of an exemplary optical loupe assembly utilizing liquid lens assemblies to vary the magnification of objects in accordance with the principles of the present invention.

FIG. 3 is a schematic representation of an exemplary optical loupe assembly utilizing a liquid crystal lens assembly to vary the magnification of objects in accordance with the principles of the present invention.

### DETAILED DESCRIPTION

In one aspect of the invention, an electronically controlled, mechanical apparatus is incorporated into an optical loupe so that the internal loupe lens configuration can be manipulated to effect a change in magnification (zoom optical loupe). In one embodiment, the concept may include using so-called miniature control motors and gears, or equivalent devices, on the scale of a small digital camera (e.g. digital camera zoom optics). In another aspect of the invention, the concept includes the capability to electronically and mechanically manipulate the convergence of two such zoom loupes to effect a change in working distance (the distance from the eye to the viewing target). Electronic control may be implemented by various methods and/or structure, such as radio frequency (RF), foot pedal, direct controls on the loupe frames, or various other structure and methods suitable for controlling the magnification and/or working distance of a loupe or pair of loupes.

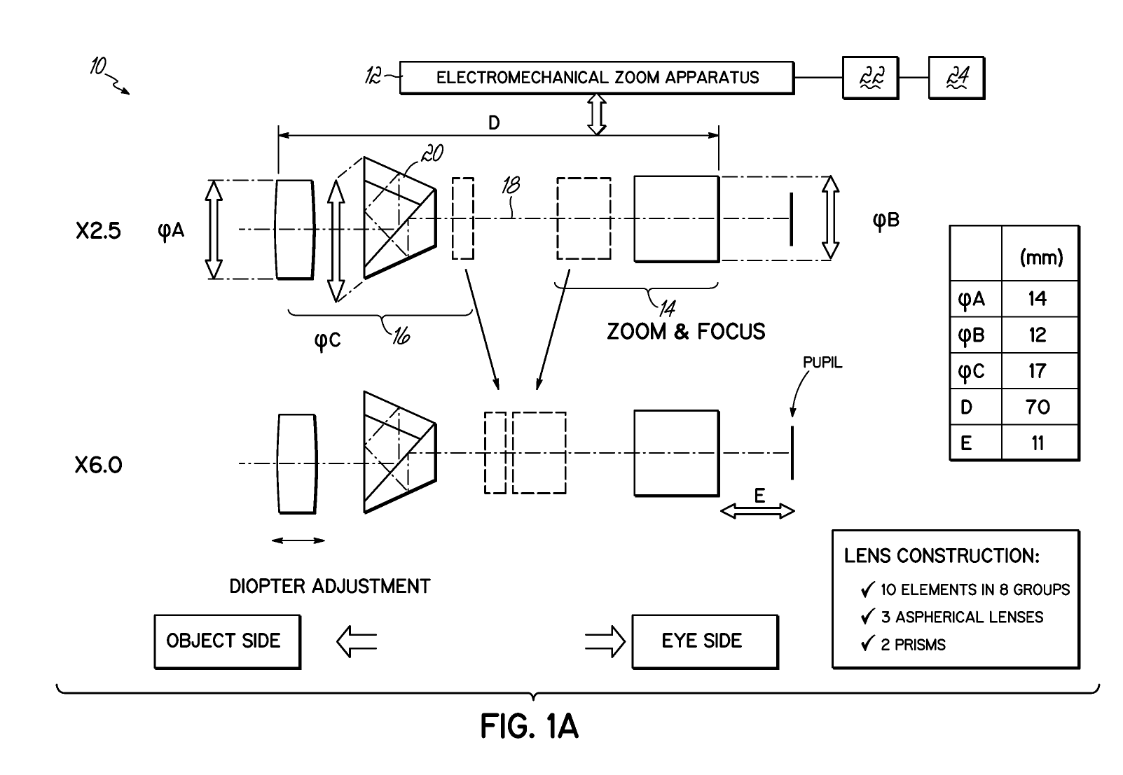

FIG. 1A depicts an exemplary optical loupe assembly 10 including an electromechanical zoom apparatus 12 for varying the magnification of the optical loupe assembly 10. The optical loupe assembly 10 includes an eyepiece lens assembly 14 and an objective lens assembly 16 aligned along an optical axis 18 to provide a magnified image of an object viewed through the optical loupe assembly 10. The eyepiece lens assembly 14 and the objective lens assembly 16 may each comprise single or multiple lens elements. The optical loupe assembly 10 may further include a prism assembly 20 aligned with the eyepiece lens assembly 14 and the objective lens assembly 16, and cooperating with the eyepiece lens assembly 14 and objective lens assembly 16 to provide a magnified image of the object. The prism assembly 20 may include a single prism element, or may include plural prism elements, as may be required. The lens and prism elements 14, 16, 20 of the optical loupe assembly 10, as well as the general construction of housing components in which the lens and prism elements are supported, may be similar to the lens and prism elements generally described in U.S. Pat. No. 6,704,142, assigned to Kerr Corporation and incorporated by reference herein in its entirety.

The electromechanical zoom apparatus 12 may directly or indirectly vary the distance between lens elements 14, 16 to thereby vary the magnification of the lens system. The electromechanical zoom apparatus 12 may also vary the distance between lens elements 14, 16 to vary the working distance of the optical loupe assembly 10.

The optical loupe assembly 10 may also be configured for automatic focusing of the image of an object viewed through the optical loupe assembly 10. In another embodiment, the optical loupe assembly 10 may also be configured for automatic convergence adjustment, to accommodate viewing objects located at different working distances. Accordingly, as the eye moves toward or away from the target object, the convergence would automatically be adjusted so that the optical loupe assembly 10, in concert with an auto focus function, would gain automatic working distance adjustment. In these embodiments, the optical loupe assembly 10 includes range-finding components 22 to determine the distance to the object, such as by ultrasound, infrared, or any other suitable method. Signals from the range-finding components 22 may be communicated to a controller 24 that controls operation of the electromechanical apparatus 12 to focus the image of the object and to adjust the convergence, as may be desired.

In another embodiment illustrated schematically in FIG. 1B, an optical loupe 10a may be configured to facilitate manual adjustment of the magnification of objects viewed through the optical loupe assembly 10b. In this embodiment, features similar to those described above with respect to the embodiment of FIG. 1 are similarly numbered. A mechanical mechanism 12a is provided to facilitate manual movement of one or more lens elements 14, 16 relative to other ones of the lens elements so that magnification can be selectively adjusted by the user. As a non-limiting example, a mechanical mechanism 12a may be provided to facilitate slidably moving one or more of the lens elements 14, 16 relative to other ones of the lens elements 14, 16. The mechanical mechanism 12a may include a control, such as a lever or dial, that can be manually manipulated by a user to move the one or more lens elements 14, 16 and thereby vary the magnification. In another non-limiting example, the mechanical mechanism 12a may include a rack gear to which one or more lens elements 14, 16 are coupled for movement relative to other ones of the lens elements 14, 16. A pinion gear is operatively engaged with the rack gear and can be turned by a user, such as by turning a knob or dial coupled with the rack gear, to thereby move the one or more lens elements 14, 16 relative to the other lens elements 14, 16. It will be appreciated that various other mechanical mechanisms 12a may be provided to permit manual adjustment of the magnification by a user.

In another embodiment, variable magnification may be provided by a liquid lens assembly comprising one or more liquid lens systems. Liquid lens systems utilize one or more liquid materials to change the path of light passing through the lens system and thereby vary magnification without the need for motors or other moving mechanical components. For example, U.S. Pat. No. 7,680,406 to Jung and U.S. Pat. No. 7,791,814 to Liogier D'ardhuy et al. disclose liquid lens assemblies that use electro-wetting to change the shape of a meniscus between two non-miscible liquids, thereby varying the magnification of the lens assemblies. U.S. Pat. No. 7,680,406 and U.S. Pat. No. 7,791,814 are incorporated by reference herein in their entirety.

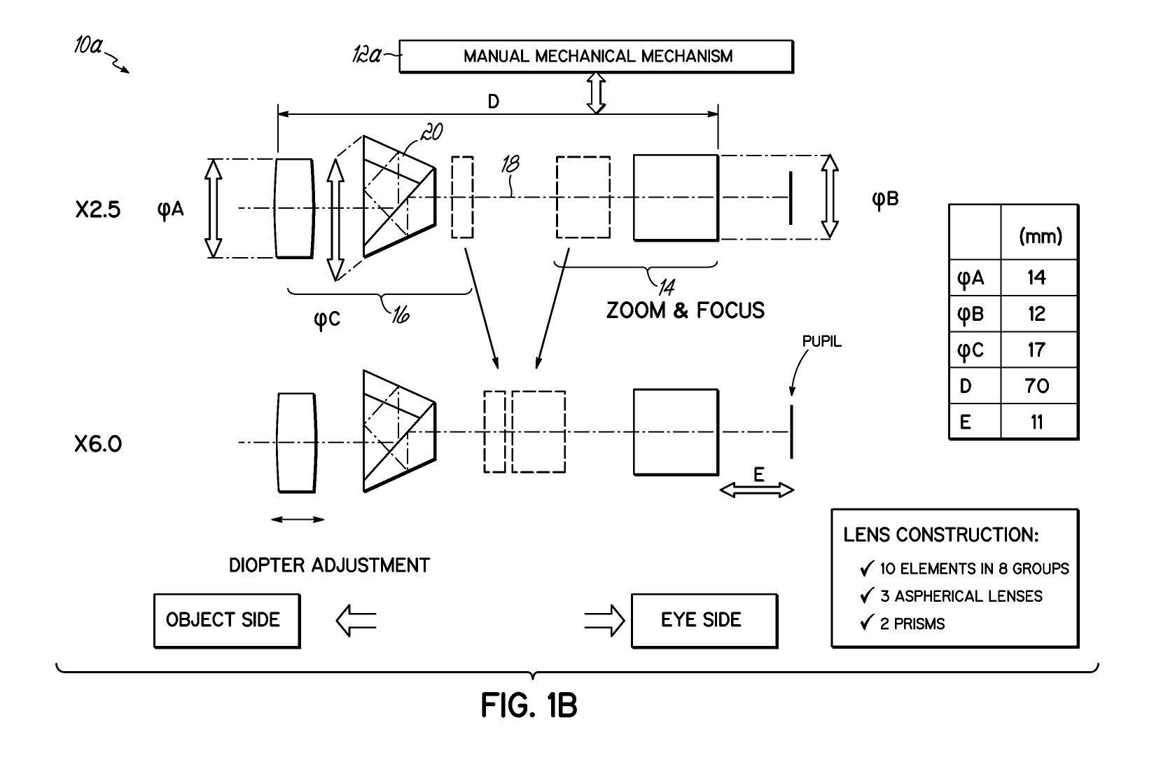

FIG. 2 depicts an exemplary optical loupe assembly 30 including multiple solid lenses 32, 34, 36 and two liquid lens assemblies 38, 40. An optical loupe system in accordance with the principles of the present disclosure may utilize one of the liquid lens assemblies 38, 40 for varying magnification and another one of the liquid lens assemblies 38, 40 for adjusting zoom, focus, or the working distance of the optical loupe assembly 30. The optical loupe assembly 30 may be configured for automatic adjustment of focus and/or working distance, as discussed above. While an optical loupe assembly 30 having two liquid lens assemblies 38, 40 is shown and described herein, it will be appreciated that an optical loupe assembly in accordance with the principles of the present invention may alternatively use only a single liquid lens assembly, or may use more than two liquid lens assemblies, as may be desired to achieve a particular optical performance.

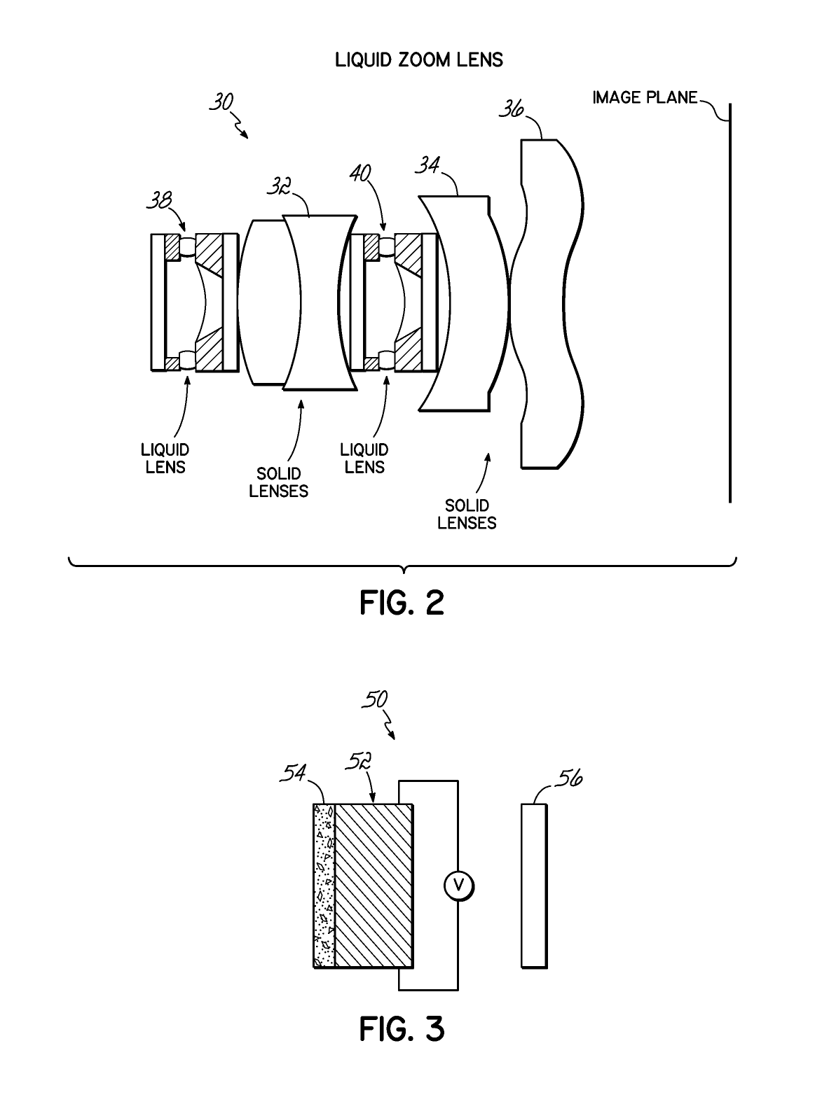

In yet another embodiment depicted schematically in FIG. 3, an optical loupe assembly 50 may include one or more liquid crystal lens elements 52 that facilitate varying the magnification of objects viewed through the optical loupe assembly 50 by varying a voltage applied to the liquid crystal lens element 52. In one aspect, the liquid crystal lens element 52 includes a layer of liquid crystals 54 whose orientation can be changed by varying the voltage V applied to the layer of liquid crystals 54, thereby changing the refraction through the lens element 52 and affecting magnification and focus without the need for motors or other moving mechanical components. The optical loupe assembly 50 may further include additional lens elements, such as an eyepiece lens 56, or any other lens elements as may be desired.

While the present invention has been illustrated by the description of one or more exemplary embodiments, and while the embodiments have been described in considerable detail, they are not intended to restrict or in any way limit the scope of the appended claims to such detail. The various features discussed herein may be used alone or in any combination. Additional advantages and modifications will readily appear to those skilled in the art. The invention in its broader aspects is therefore not limited to the specific details, representative apparatus and method and illustrative examples shown and described. Accordingly, departures may be made from such details without departing from the scope or spirit of the general inventive concept.

What is claimed is:

1. An optical loupe, comprising:
at least one eyepiece lens;
at least one objective lens; and
an actuator cooperating with said eyepiece lens and said objective lens and operative to vary a magnification of an image viewed through said eyepiece lens and said objective lens.

2. The optical loupe of claim 1, wherein said actuator comprises mechanical components that are manually actuatable by a user.

3. The optical loupe of claim 1, wherein said actuator is electromechanical.

4. The optical loupe of claim 1, further comprising:
a prism cooperating with said objective lens and said eyepiece lens to magnify an image viewed through the optical loupe.

5. The optical loupe of claim 1, wherein said actuator further operates to vary a working distance of the optical loupe.

6. The optical loupe of claim 1, wherein said actuator is further configured to automatically focus the image viewed through said eyepiece lens and said objective lens.

7. The optical loupe of claim 1, wherein said actuator is further configured to automatically vary the convergence.

8. An optical loupe, comprising:
at least one liquid lens assembly operative to vary a magnification of an image viewed through the loupe; and
a power source providing a voltage potential to said at least one liquid lens assembly.

9. An optical loupe, comprising:
at least one liquid crystal lens assembly operative to vary a magnification of an image viewed through the loupe; and
a power source providing a voltage potential to said at least one liquid crystal lens assembly.
